(19) United States
(12) Patent Application Publication
(10) Pub. No.: US 2026/0213047 A1
(43) Pub. Date: Jul. 23, 2026

(54) METHOD FOR FURTHER PROCESSING A WIRE CHAIN

(71) Applicant: SW Automatisierung GmbH, Golling an der Salzach (AT)

(72) Inventors: Johannes SCHAUER, Kuchl (AT); Rupert LINDNER, Kuchl (AT); Felix GRUENWALD, Bischofshofen (AT)

(21) Appl. No.: 19/447,788

(22) Filed: Jan. 13, 2026

(30) Foreign Application Priority Data
Jan. 17, 2025 (AT) A 50019/2025

(51) Int. Cl. H01B 13/012

(52) U.S. Cl. CPC H01B 13/01263

(57) ABSTRACT

A method is provided for further processing a wire chain by a processing module of a wire processing machine. In a preparatory method step, at least two wires are connected to each other, preferably by an adhesive strip and/or are spatially spaced apart, so that the at least two wires are provided in the form of a wire chain, and the wire chain is fed to the processing module, preferably individually, and bundled via a bundling device of the processing module. The bundled wire chain is connected by the processing module to form, preferably exactly, a wire bundle by a fixing means.

### BACKGROUND OF THE INVENTION

The invention relates to a method for further processing a wire chain using a processing module of a wire processing machine. Furthermore, the invention relates to a processing module for a wire processing machine for carrying out such a method and to a wire processing machine with at least one such processing module.

Traditionally, a large number of wires are processed automatically by a wire processing machine for further processing or direct application—for example, for direct connection to an electrical device—essentially according to two varying concepts. Either the individual wires are bundled together, or the individual wires are processed into a wire chain. A wire chain is characterized by the fact that the individual wires are successively arranged chronologically—for example on adhesive strip—and connected to each other.

A disadvantage of the prior art with regard to a bundle of wires is that the sequence of the wires
as they are subsequently processed or intended for use—is lost. A disadvantage of the prior art with regard to a wire chain is, in terms of integration into wire processing machines, that not only the sequence of the individual wires is relevant with regard to further logistics, but also the handling of the individual wire chains. However, these are temporarily stored in a storage device by the wire processing machine, wherein, particularly due to the cycle time of the wire processing machine, twisting, tangling and/or entanglement of the individual wires and/or bundles quickly occurs. The result is a tangled conglomerate of wire chains and wires, in which an unsorted, unassignable and difficult-to-untangle quantity of wires/wire chains is present in the storage device, which entails further use with additional work steps and time delays as well as a low level of user comfort or the practical impossibility of using a higher degree of automation.

### SUMMARY OF THE INVENTION

The object of the present invention is therefore to provide a method which is improved with respect to the prior art, for further processing at least one wire chain and a processing module for a wire processing machine, in which the drawbacks of the prior art are at least partially eliminated, and which is characterized in particular by the provision of wire chains in a form suitable for simplified further processing.

According to the invention, a method for further processing at least one wire chain by a processing module of a wire processing machine is provided, in which the following process steps are carried out:
In a preparatory method step, at least two wires are connected to each other, preferably by means of adhesive strip and/or spatially spaced apart, so that the at least two wires are provided in the form of at least one wire chain, and
the at least one wire chain is fed to the processing module, preferably individually, and bundled via a bundling device of the processing module, wherein the at least one bundled wire chain is connected by the processing module to form, preferably exactly, a wire bundle by means of at least one fixing means.

This makes it possible for a plurality of wire bundles, which are output by the wire processing machine, to be provided in a form that inhibits the tendency to interlock and/or can be conveniently removed by a storage device for further processing.

The process steps generally do not have to be carried out sequentially. For example, feeding into the processing module can take place in parallel with the formation of the at least one wire chain. Preferably, wire chains are individually and iteratively bundled together—consisting of one respective wire chain or a plurality of wire chains—by at least one fixing means, although this is generally not strictly necessary. Furthermore, a plurality of wire bundles can be produced—one after the other or in parallel—as part of the process.

In addition, the positive property is that the sequence of wires to be processed is maintained by the at least one fixing means, which is generally present in addition to a holding means for connecting the individual wires of the at least one wire chain, reducing the risk of damage to the at least one wire chain and/or offering the possibility of providing additional information (for example, via at least one identification means)—such as an assignment of the at least one wire chain for the intended application, a number and/or type of wires included, a batch and/or order number. This allows the wire processing machine, for example, to automatically generate and eject 100 wire chains for 50 orders of 100 wire bundles, which can then be easily removed from the wire processing machine by a user—without having to unravel the individual wire chains—and wherein the user readily recognized which wire bundle it is and for what purpose it is intended. The geometry of the wire bundle also enables automated further processing and/or recognition of the wire bundles downstream of the production of the wire bundles.

On the one hand, (exactly) one wire chain can be converted into a wire bundle in compact form. On the other hand, a plurality of wire chains can be combined into (exactly) one wire bundle, which can offer particular advantages for the production and/or logistics process.

It is also conceivable, for example, to feed six wire chains into the processing module in order to produce a wire bundle consisting of one wire chain, a wire bundle consisting of two wire chains and a wire bundle consisting of three wire chains—preferably sequentially.

Typically used wires have a length of 150 mm to 1200 mm, although the wires can also have a length of, for example, 30 m. The individual wires of the at least one wire chain or of the generated wire bundle or bundles can have varying lengths or the same length. A wire chain can, for example, comprise 100 wires, while typical wire chains comprise approximately 50 wires. A wire of the at least one wire chain or wire bundle preferably has a cross-section of 0.5 mm² to 6 mm², wherein the spectrum and dimensioning of the wires are generally arbitrarily selectable.

At least one, preferably two, conductor end pieces are preferably arranged on at least one wire. The plurality of wires may have different or identical conductor end pieces. Preferably, the conductor end piece is in the form of a wire end sleeve, crimp connection or the like. For example, a wire chain or a plurality of wire chains in a bundle may comprise identical or different conductor end pieces.

The at least one fixing means can be arranged at the same free end of the wires where the wires are bundled together to form a wire chain by an adhesive strip. If at least one fixing means is placed at a free end of the wire chain facing away from the adhesive strip, a particularly compact bundle can be achieved. In general, the bundle can be provided with the at least one fixing means on one or both sides.

Preferably, the wire chain is provided with the at least one fixing means over both free ends, so that the wire bundle is provided in a loop-like fashion with free ends arranged adjacent to each other. This can result in a particularly compact bundle.

The at least one fixing means preferably has a substantially square geometry and/or dimensions of approximately 150 mm by 20 mm, wherein the shape and dimensions of the at least one fixing means can generally be arbitrarily designed.

Preferably, the method is carried out fully automatically—in particular, the provision of the wire chain in or outside the processing module and/or the feeding of the wire chain into the processing module (with a suitably configured drive device/control unit).

Preferably, the wire chain is formed by a wire chain supply device on the processing module, preferably during the insertion of the wire chain into the bundling device.

As stated at the outset, protection is also sought for a processing module for a wire processing machine for carrying out such a method, comprising a bundling device for bundling at least one wire chain comprising at least two wires connected to each other, preferably by means of an adhesive strip and/or spatially spaced apart from each other, characterized in that the processing module comprises a fixing means which is configured to automatically connect the at least one wire chain supplied to the bundling device to form at least one wire bundle by means of at least one fixing means.

The bundling device is generally provided to transform the at least one wire chain into a form which is particularly suitable for bundling and fixing it into a wire bundle. The fixing means is generally designed to generate the transition from at least one wire chain to a wire bundle. It is particularly preferred that both the bundling device and the fixing means are integrated into the wire processing machine in such an automated manner that no manual work steps are required.

For example, a wire chain supply device can be provided upstream of the bundling device and arranged on the processing module, with which a wire chain can be provided before or during the bundling of the wire chain.

As stated at the outset, protection is also sought for a wire processing machine with at least one such processing module.

In general, at least one control or regulating device is implemented to control the component parts for bundling the at least one wire chain into a wire bundle. In this regard, a separate drive and control unit can be provided for each component or assembly, or a common drive and control unit can be provided for at least two components or assemblies. The control or regulating device can be integrated into the processing module or the wire processing machine, or it can be in the form of a decentralized control or regulating device. The number of wire chains or wire bundles to be processed in parallel or successively is generally arbitrary. For example, two bundling devices can be provided for a different number of wires per wire chain. For example, the bundling device or the fixing means can be controlled depending on the number of wires in the respective wire chain or wire chains.

According to an advantageous embodiment, at least one of the following steps is carried out, preferably automatically by at least one drive device configured for this purpose and/or depending on the dimensioning of the at least one wire chain:
at least one fixing means is printed, preferably before being attached to the at least one wire chain.
the at least one fixing means is cut
the at least one fixing means is maneuvered to the at least one bundled wire chain
the at least one fixing means is guided around the at least one bundled wire chain and/or brought together over two free ends, preferably glued together,
the wire bundle is ejected from the bundling device and/or removed
the wire bundle is temporarily stored on a storage device together with at least one other wire bundle.

For example, an exemplary method for manufacturing a wire bundle that has proven to be particularly efficient can be explained as follows: A plurality of wires are joined together by adhesive strip to form at least one wire chain, which is placed in the bundling device and bundled. Subsequently, a fixing means in the form of an adhesive strip is printed with an identification means, cut to size and maneuvered to the at least one bundled wire chain using two suction cups (as a means of transport). Subsequently, the fixing means, which is in the form of an adhesive strip, is guided around the at least one bundled wire chain by means of two rollers through strokes of a pneumatic device and glued over the free ends of the adhesive strip (the adhesive strip can be provided with adhesive/bonding means completely on one side or only in regions of one side). The suction cups then return to their starting position and the bundling device is spread open, wherein a different movement trajectory than relative movement between the wire bundle and the bundling device (such as displacement of the bundling device or the wire bundle) may also be provided. The wire bundle can be transferred by means of a chute designed as an inclined plane or directly onto a storage device for the temporary storage of a plurality or individual wire bundles (direct transfer for further processing is also possible).

According to an advantageous embodiment, the at least one fixing means is in the form of an adhesive strip. An adhesive strip has proven to be particularly suitable for bundling wire chains due to its suitability for printing and its material-specific characteristics regarding flexibility, allowing for flexible adaptation to the dimensions of at least one wire chain. In general, however, alternative or supplementary fixing means, such as a cable tie, a Velcro fastener, a lacing, a rubber ring, a clip connection or similar means for fixing the at least one wire chain to a wire bundle, are conceivable.

In general, it is not necessary to glue at least one fixing means—for example, in the case of a cable tie—to itself over two free ends. For example, the wire chain can be wrapped with the at least one fixing means—for example, with a cord, adhesive strip, etc.

Preferably, at least one identification means, preferably a QR code or ID code, for assigning the respective wire bundle is arranged on the at least one fixing means. The at least one identification means not only facilitates a simpler connection of the at least one wire chain to the order, the production or the area of application, but also enables IT-supported further processing, in which the wire bundle is captured and recognized, for example, via pattern recognition by a scanning device or a camera. For example, the identification means can be in the form of an RFID chip, with an optical assignment code (such as an ID number, a label or a QR code) being particularly preferred.

It has proven advantageous that the bundling device includes a geometry essentially designed in a U-shape for depositing at least one wire chain during a bundling process. A U-shape can, simply by virtue of its shape, provide sufficient bundling of at least one wire chain. The bundling device may include bundling means as an alternative or supplement to the geometry in order to transform the at least one wire chain into a further bundled form. In general, bundling can be achieved by the fixing device in interaction with the bundling device (which can also generally be located, for example, in a planar storage area).

It is particularly preferred that the bundling device comprises a bundling unit movable for bundling relative to the at least one wire chain, preferably a swivel arm, and/or a drive device. Preferably, the drive device is designed as a pneumatic device. The drive device enables the automation of the production of the wire bundles. In the context of the invention, this can be considered a drive for all component parts—individually or collectively—although it is not necessarily the case that all component parts have to be driven.

According to a preferred exemplary embodiment, the bundling device is designed to be at least two-part and/or to be expandable for ejecting the wire bundle, preferably by a drive device that may be present. This eliminates the need for translational movement of the wire bundle or the bundle device, and the wire bundle can, for example, fall downwards out of the processing module due to gravity. In general, a gripper may be provided for removing the wire bundle, although this is not necessary.

According to an advantageous embodiment, at least one, preferably two, rollers are provided for attaching the at least one fixing means to the at least one bundled wire chain, and it is preferably provided that the at least one roller is movable relative to the bundling device by means of a drive device that may be present. By means of a roller which, for example, is freely rotatable around the at least one bundled wire chain, the at least one fixing means can be attached to the wire chain particularly efficiently and depending on the specific geometry of the at least one wire chain—particularly preferably by means of an adhesive/bonding means.

Preferably, a printing device is provided for printing on the at least one fixing means, preferably with at least one identification means. If the printing device is integrated into the processing module, the desired labeling or imprint can be applied individually and just in time. Preferably, a cutting device, preferably driven or driveable by a drive device if present, is provided for cutting the at least one fixing means to length.

Since the range of possible wire chains or plurality of wire chains is broad, a suitable fixing means can be provided in the bundling process by means of a cutting device. In general, the cutting device can, for example, be used as a fixing means in a selection device to provide a specific type of cable tie (with a specific length) when a cable tie is present. However, in the case of cable ties, a cutting device can also be dispensed with.

Preferably, at least one, preferably two and/or a transport means, preferably a suction cup, is provided, which is driven or driveable by a drive device if present, with which the at least one fixing means, preferably by a pressure device if present, can be moved to the at least one bundled wire chain. Alternatively, the at least one fixing means is already located in such a way relative to the at least one bundled wire chain that the at least one fixing means can be applied directly around the at least one wire chain.

It is particularly preferred that a storage device for storing a plurality of wire bundles is provided, wherein preferably an inclined plane is arranged between the bundling device and the storage device.

With an inclined plane, complex and controllable transport devices can be dispensed with to feed the wire bundles to the storage device. If the storage device is located vertically below the bundling device, the inclined plane can also be omitted. The storage device allows for the temporary storage of a large number of wire bundles, since the cycle time of the wire processing machine generally does not correspond to the cycle time for further processing, where, for example, the wire processing machine operates automatically and further processing subsequently takes place on a batch of wire bundles. Direct transfer or transport without intermediate storage of the wire bundles is also possible and is made easier or more secure, especially when an identification means is available.

According to a preferred exemplary embodiment, the processing module is provided with at least one wire chain and/or the at least one wire bundle. The at least one wire chain comprises a plurality of interconnected wires, and preferably, the plurality of wires is in the form of wires partially freed from insulation.

It has proven advantageous that a wire chain supply device, preferably of the at least one processing module, is provided for supplying at least one wire chain and/or at least one transport device with which at least one wire chain can be supplied to the processing module and/or the at least one wire bundle can be transported away from the bundling device and/or a possibly existing storage device.

A transport device allows the processing module to be integrated particularly favorably as an entity for the automated bundling of wire chains into the generally also automated process of providing the at least one wire chain or further processing. Particularly preferably the wire bundle is temporarily stored on the storage device together with at least one other wire bundle.

### BRIEF DESCRIPTION OF THE DRAWINGS

Further details and advantages of the present invention will be explained in more detail below with reference to the drawings, in which:

FIGS. 1a, 1bshow a comparison of a wire chain before a bundled state and in a bundled state as well as a wire bundle with the individual wires fixed both with adhesive tape and with a fixing means in the form of an adhesive strip,

FIGS. 2a-2l show a processing module for a wire processing machine according to a preferred exemplary embodiment for visualizing a process of manufacturing a wire bundle starting from a wire chain in perspective views,

FIG. 3 shows a wire processing machine with the processing module according to the embodiment according to FIG. 2a in a perspective view.

### DETAILED DESCRIPTION OF THE INVENTION

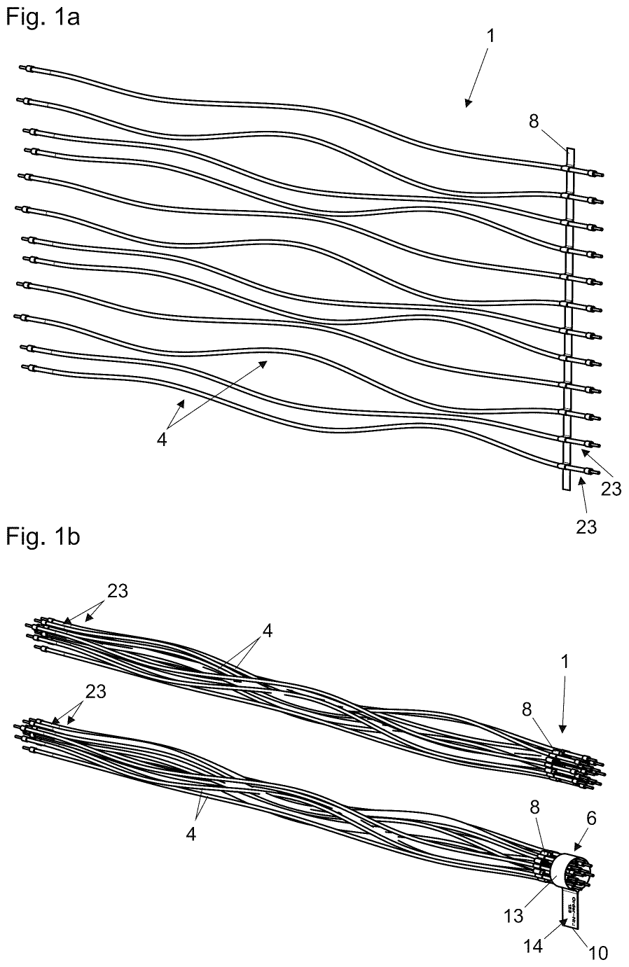

FIG. 1a shows a wire chain 1 comprising a plurality of wires 4, with a conductor end piece arranged on each of the wires 4. The number of conductor end pieces per wire 4, and the type of conductor end piece is generally arbitrary. The number of wires 4 per wire chain 1 and the number of wire chains 1 is generally arbitrary for the production of a wire bundle 7 or a plurality of wire bundles 7.

The wire chain 1 comprises a plurality of wires 4 connected to each other by means of an adhesive tape 8 and spatially spaced apart from each other in spread-out form, wherein the wires 4 generally contact each other in bundled form.

The plurality of wires 4 are each in the form of wires 4 partially freed from insulation 23, wherein the specific design of the wires 4—for example, the conductor end piece—is generally arbitrary.

FIG. 1b shows a bundled wire chain 1 in the above figure, wherein in general a plurality of wire chains 1 can be bundled together. In the lower figure a wire bundle 7 is shown as the end product, wherein in an analogous manner a single wire chain 1 or a plurality of wire chains 1 can be bundled and the wires 4 can be of different types (length, cross-section, conductor end piece, etc.).

The wire bundle 7 is formed by means of a fixing means 6, wherein the number, type and positioning of the fixing means 6 is generally arbitrary. For example, a cable tie or a plurality of fixing means 6 may be provided, or both free ends of the bundled wire chain 1 may be joined together to form a loop via the fixing means 6.

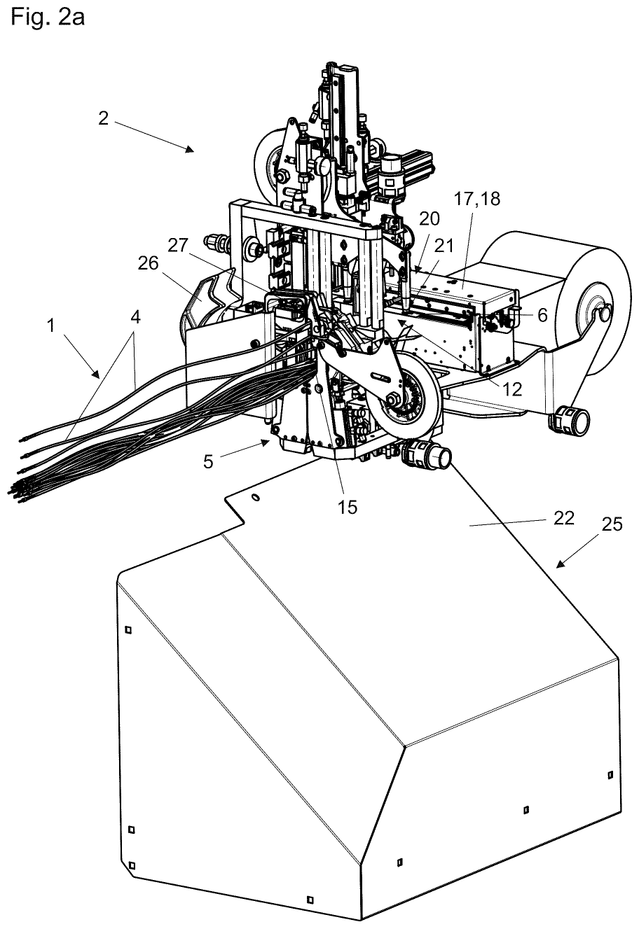

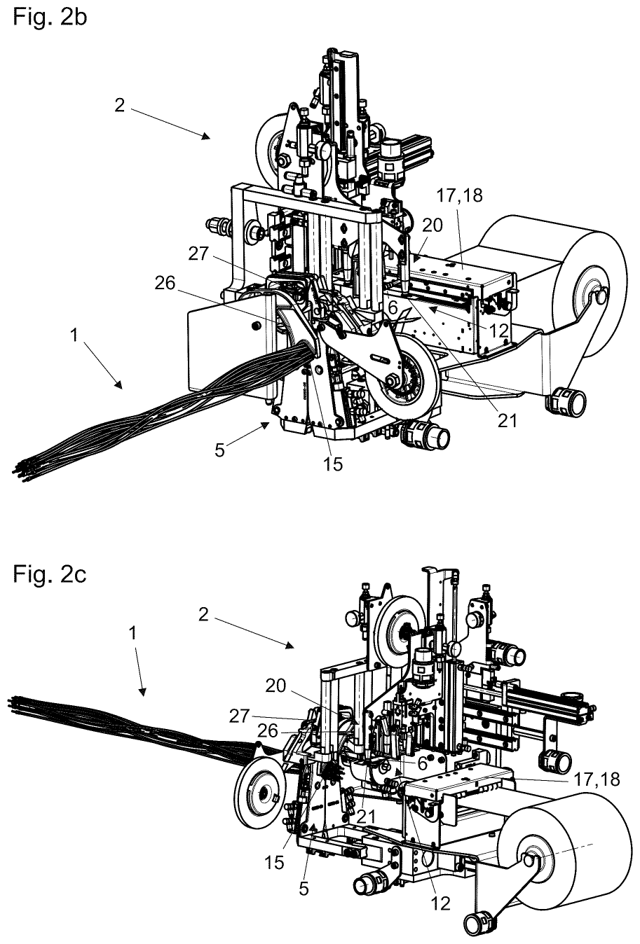

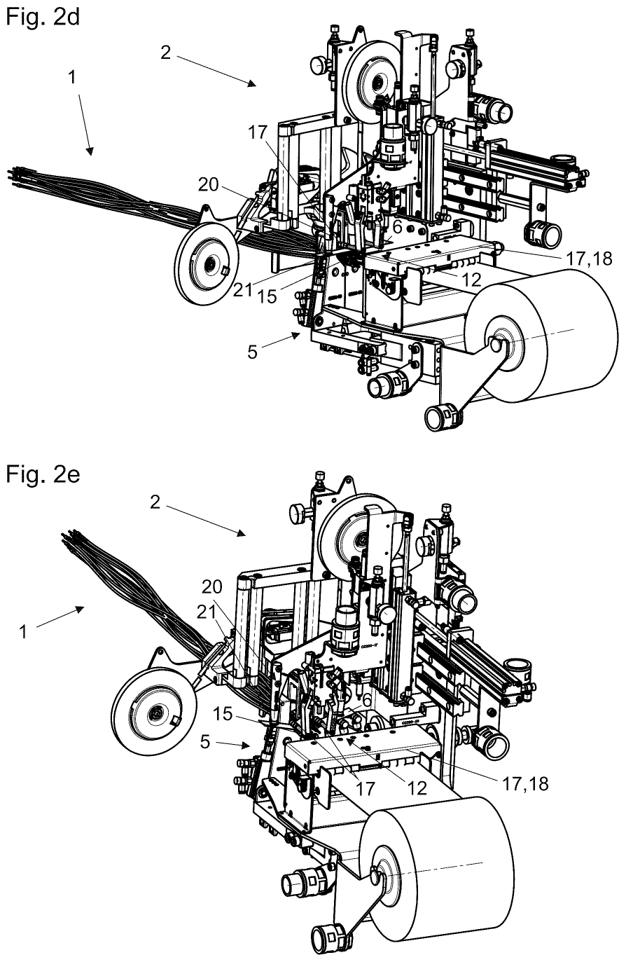

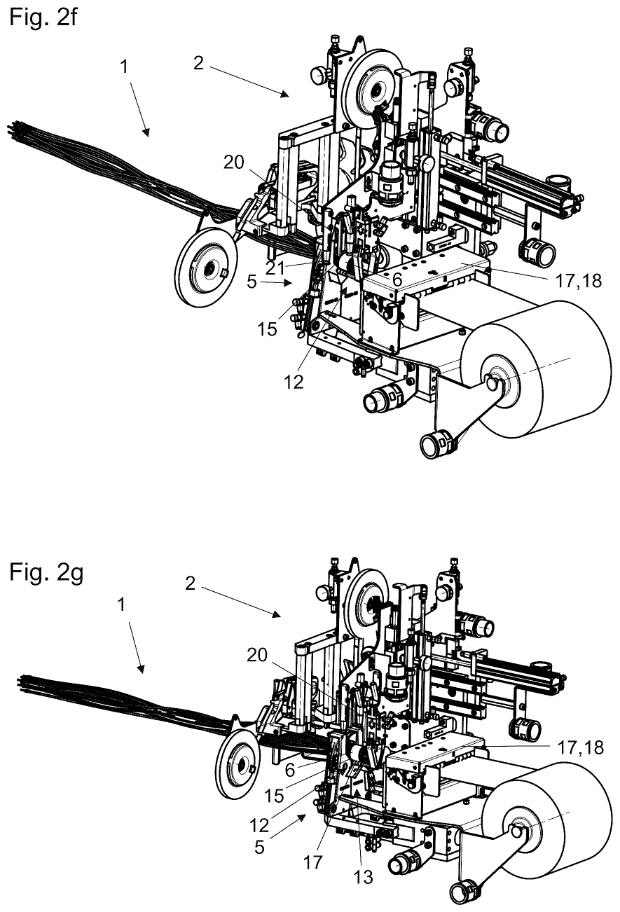

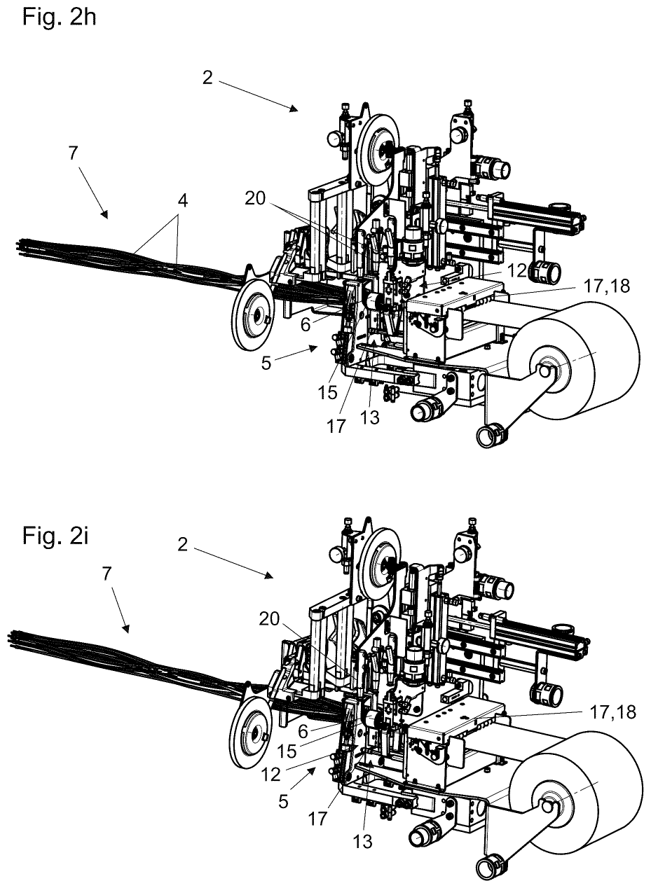

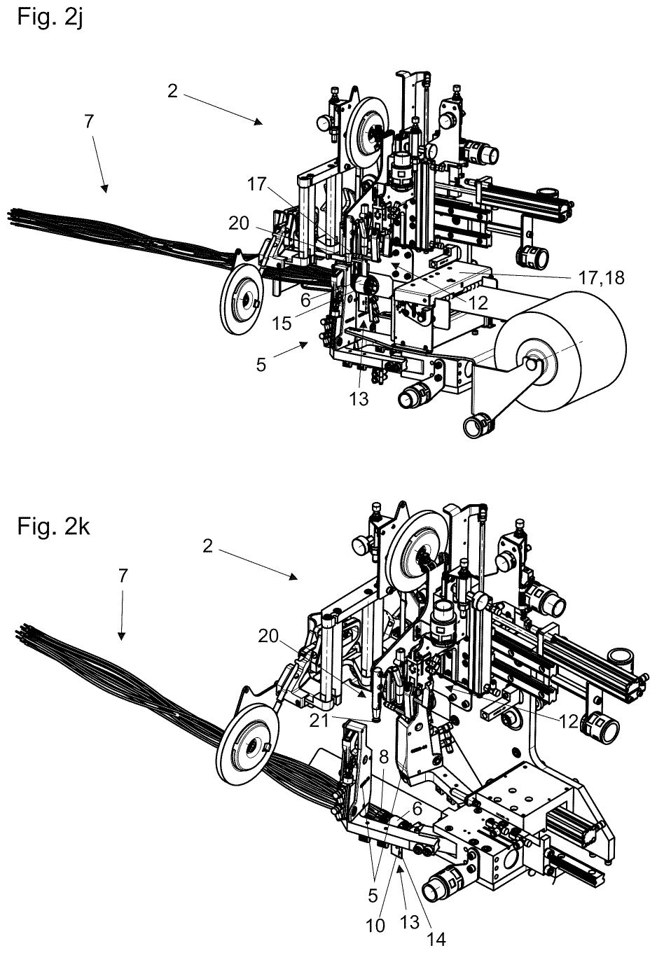

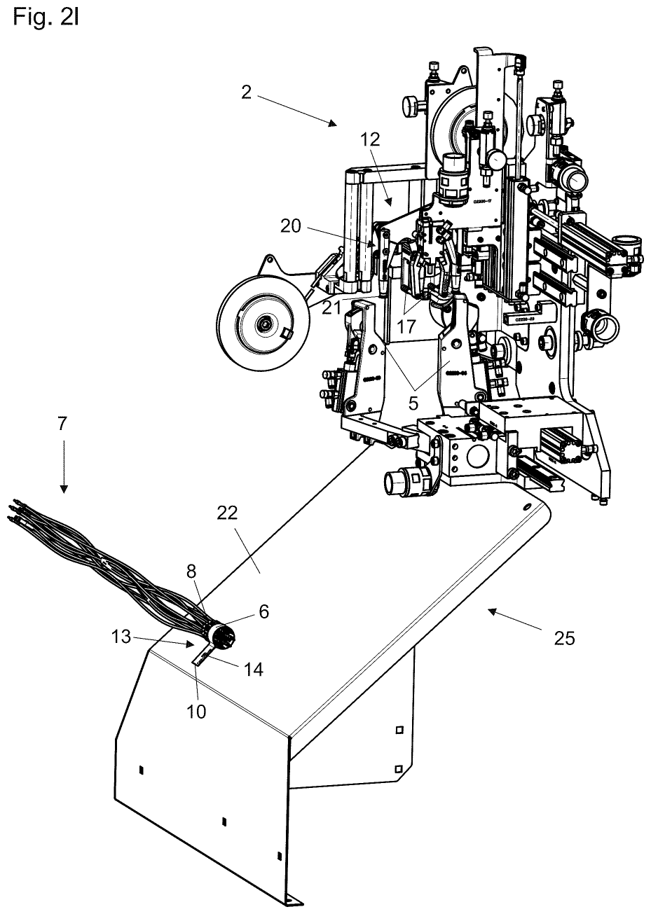

FIGS. 2a to 2l visualize an exemplary method for further processing a wire chain 1 using a processing module 2 of a wire forming machine 3, which can be explained as follows: In a preparatory process step, at least two wires 4 are joined together by means of an adhesive tape 8, so that the at least two wires 4 are provided in the form of one (or more) wire chain 1, and the wire chain 1 is fed to the processing module 2 and bundled via a bundling device 5 of the processing module 2, wherein the bundled wire chain 1 is joined by the processing module 2 by means of the fixing means 6 to form a wire bundle 7.

In this exemplary embodiment, the following steps are carried out automatically by adrive device 9 configured for this purpose: The fixing element 6 is printed before being attached to the wire chain 1, the fixing element 6 is cut, the fixing element 6 is maneuvered to the bundled wire chain 1, the fixing element 6 is guided around the bundled wire chain 1 and joined together over two free ends 10, the wire bundle 7 is ejected from the bundling device 5 and the wire bundle 7 is temporarily stored together with other wire bundles 7 on a storage device 11.

In general, it is possible to control the drive device 9 depending on the dimensioning of the wire chain 1 or the wire chains 1, to provide another fixing means 6 or other fixing means 6, or to attach the fixing means 6 to the wire chain 1 or the wire chains 1 in another way. Furthermore, wire bundles 7 can be transported directly to a subsequent workstation without intermediate storage.

FIG. 2a shows a preferred embodiment of a processing module 2 for a wire processing machine 3 for carrying out the method, wherein the processing module 2 comprises a bundling device 5 for bundling the wire chain 1 or wire chains 1 and a fixing means 12, wherein the fixing means 12 is configured to automatically join the wire chain 1 or wire chains 1 supplied to the bundling device 5 to form at least one wire bundle 7 by means of at least one fixing means 6.

At the processing module 2, at least one wire chain 1 and subsequently at least one wire bundle 7 comprising a plurality of interconnected wires 4 are arranged.

Below the bundling device 5 an inclined plane 22 is arranged to facilitate the further transport of the wire bundles 7, wherein the inclined plane 22 is not absolutely necessary and is hidden in FIGS. 2b to 2k for the sake of clarity.

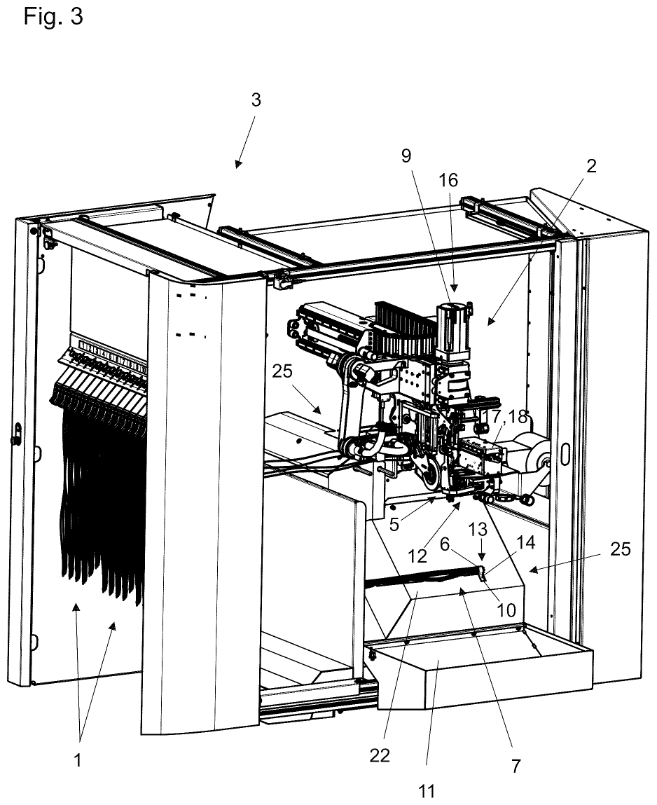

In the position of the processing module 2 shown, the individual wires 4 of the wire chain 1 are collected in the bundling device 5. Three suction cups 21 of a transport means 20, which are controlled via a drive device 9 (see FIG. 3), hold the fixing means 6 in the form of an adhesive strip 13 in order to maneuver the fixing means 6 to the desired position for the wire bundle 7 by moving the transport means 20 or the subsequently bundled wire chain 1.

The fixing means 6 was previously provided by a unit comprising a printing device 18 for printing the fixing means 6 with an identification means 14 and a cutting device 19 for cutting the fixing means 6 to length.

In general, the wire chain 1 can already be fed to the bundling device 5 as wire chain 1. According to the exemplary embodiment shown in FIG. 2a, the wire chain 1—this is generally possible—is produced (temporarily in parallel) by a wire chain supply device 27 during the process of being introduced into the bundling device 5.

FIG. 2b shows that the bundling device 5 includes a swivel arm 26 to bring the wire chain 1 arranged in the bundling device 5 into a further bundled shape by applying pressure. The swivel

arm is driven, although this is not strictly necessary. Alternatively or in addition to the swivel arm 26, a translationally movable bundler may be provided, for example.

The bundling device 5 comprises a geometry designed as a U-shape 15 for depositing the wire chain 1 during the bundling process, wherein other geometries may be provided.

FIG. 2c differs from FIG. 2b only in that it is viewed from a different angle.

FIG. 2d shows that the distance between the bundled wire chain 1 and the fixing means 6 has been reduced.

The bundler can either be already returned to its starting position or remain in the position shown in FIG. 2b.

FIG. 2e shows that the fixing device 12 comprises rollers 17 arranged in pairs (the number is generally arbitrary) for attaching the fixing means 6 to the bundled wire chain 1.

The rollers 17 are moved automatically relative to the bundling device 5 by the drive device 9.

FIG. 2f shows that the rollers 17 - in which case another means of exerting pressure may also be provided—were moved downwards in a vertical direction, wherein the rollers 17 are guided by a pliers mechanism in such a way that the fixing means 6 is guided/glued around the bundled wire chain 1.

In this position of the processing module 2, the fixing means 6 is held only by one of the three suction cups 21, wherein the connection to the transport means 20 may be omitted.

FIG. 2g differs from FIG. 2f only in that the rollers 17 were moved further downwards in a vertical direction.

In FIG. 2h and FIG. 2i, the connection of the fixing means 6 by the fixing device 12 is completed, so that a wire bundle 7 is present.

In this exemplary embodiment with the fixing means 6 as adhesive strip 13, a connection via two free ends 10 of the adhesive strip 13 was chosen, wherein an identification means 14 is visible.

FIG. 2j shows that the fixing means 12 was again returned to its starting position to ensure timely preparation for the next wire bundle 7.

FIG. 2k shows that the bundling device 5 for ejecting the wire bundle 7 is designed in two parts, wherein the two parts of the bundling device 5 are spread apart by the drive device 9.

FIG. 2l shows the discharge of the wire bundle 7 of this embodiment via the inclined plane 22 of the transport device 25, wherein the wire bundle 7 slides or falls towards a chute due to gravity.

On the fixing means 6 an identification means 14 in the form of an ID code or QR code is arranged for the assignment of the respective wire bundle 7 via a detection device or a user of the wire processing machine 3 or for downstream handling.

FIG. 3 shows a wire processing machine 3 with a processing module 2, wherein a plurality of wire chains 1 are processed into wire bundles 7 by the processing module 2.

The wire processing machine 3 comprises one respective transport device 25, with which the wire chains 1 can be fed to the processing module 2 and the wire bundle 7 or wire bundles 7 can be transported away from the storage device 11. In general, transport directly from bundle device 5 is possible.

FIG. 3 shows that the processing module 2 comprises a drive device 9 with which the bundling device 5 and the fixing means 12 can be driven. The drive device 9 is configured accordingly, regardless of whether a common drive device 9 or a plurality of drive devices 9—for example, one drive device 9 each for the bundling device 5 and the fixing device 12—is provided. Each unit can also have multiple drive devices 9.

The type of drive device 9 is generally arbitrary and is preferably operated as an electric and/or pneumatic drive device 9 for the bundling device 5 and/or the fixing device 12.

The wire processing machine 3 can comprise additional modules—such as a wire end processing station or a crimping station. Wires 4 can, for example, be fed into a wire rail or the processing module 2, in the latter case forming at least one wire bundle 7.

The processing module 2 comprises a storage device 11 for storing a plurality of wire bundles 7, wherein the inclined plane 22 is arranged between the bundling device 5 and the storage device 11.

1. A method for further processing at least one wire chain by a processing module of a wire processing machine, the method comprising:
in a preparatory step, connecting at least two wires to each other, preferably by an adhesive strip and/or are spatially spaced apart, so that the at least two wires are provided in the form of at least one wire chain, and
feeding the at least one wire chain to the processing module, preferably individually, and bundled via a bundling device of the processing module, wherein the at least one bundled wire chain is connected by the processing module to form, preferably exactly, a wire bundle by at least one fixing means.

2. The method according to claim 1, further comprising, preferably automatically by at least one drive device configured for this purpose and/or depending on the dimensioning of the at least one wire chain, at least one of:
printing the at least one fixing means, preferably before being attached to the at least one wire chain,
cutting the at least one fixing means,
maneuvering the at least one fixing means to the at least one bundled wire chain,
guiding the at least one fixing means around the at least one bundled wire chain and/or brought together over two free ends, preferably glued together,
ejecting the wire bundle from the bundling device and/or removed, and
temporarily storing the wire bundle on a storage device together with at least one other wire bundle.

3. A processing module for a wire processing machine for carrying out a method according to claim 1, comprising a bundling device for bundling at least one wire chain comprising at least two wires connected to each other, preferably by means of an adhesive tape and/or spaced apart from each other, wherein the processing module comprises a fixing device which is designed to automatically connect the at least one wire chain fed to the bundling device to form at least one wire bundle by means of at least one fixing means.

4. The processing module according to claim 3, wherein the at least one fixing means is an adhesive strip.

5. The processing module according to claim 3, wherein at least one identification means, preferably a QR code or ID code, is arranged on the at least one fixing means for assigning the respective wire bundle.

6. The processing module according to claim 3, wherein the bundling device comprises a geometry designed essentially as a U-shape for storing the at least one wire chain during a bundling process.

7. The processing module according to claim 3, wherein the bundling device comprises a bundling unit movable for bundling relative to the at least one wire chain, preferably a swivel arm, and/or a drive device, wherein it is preferably provided that the drive device is designed as a pneumatic device.

8. The processing module according to claim 3, wherein the bundling device is designed to be at least two-part and/or to be expandable for ejecting the wire bundle, preferably by means of a drive device, that may be present.

9. The processing module according to claim 3, wherein at least one, preferably two, rollers are provided for attaching the at least one fixing means to the at least one bundled wire chain, wherein it is preferably provided that the at least one roller is movable relative to the bundling device by means of a drive device, that may be present.

10. The processing module according to claim 3, wherein a printing device is provided for printing on the at least one fixing means, preferably with at least one identification means.

11. The processing module according to claim 3, wherein a cutting device, preferably driven or driveable by a drive device, if present, is provided for cutting the at least one fixing means to length.

12. The processing module according to claim 3, wherein at least one, preferably two and/or a transport means, preferably a suction cup, is provided, which is driven or driveable by a drive device, if present, with which the at least one fixing means, preferably by a printing device, if present, can be moved to the at least one bundled wire chain.

13. The processing module according to claim 3, wherein a storage device is provided for storing a plurality of wire bundles, wherein it is preferably provided that an inclined plane is arranged between the bundling device and the storage device.

14. The processing module according to claim 3, with at least one wire chain and/or the at least one wire bundle comprising a plurality of wires connected to one another, wherein it is preferably provided that the plurality of wires are each in the form of wires partially stripped of insulation.

15. A wire processing machine with at least one processing module according to claim 3.

16. The wire processing machine according to claim 15, wherein a wire chain supply device, preferably of the at least one processing module, is provided for supplying at least one wire chain, and/or at least one transport device is provided, with which at least one wire chain can be fed to the processing module and/or the at least one wire bundle can be transported away from the bundling device and/or a storage device that may be present.
